(19) United States
(12) Patent Application Publication
(10) Pub. No.: US 2010/0328967 A1
(43) Pub. Date: Dec. 30, 2010

(54) RESONANT POWER CONVERTER

(75) Inventors: Denis John Cody, Victoria (AU); Peter Alan Langford, Victoria (AU); Yalcin Haksoz, Victoria (AU)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: STETEC PTY LTD., KNOXFIELD (AU)

(21) Appl. No.: 12/448,541

(22) PCT Filed: Jul. 2, 2008
(86) PCT No.: PCT/AU2008/000974

§ 371 Date: Aug. 13, 2009

(51) Int. Cl. H02M 3/335

(52) U.S. Cl. 363/21.02

(57) ABSTRACT

A resonant power converter including synchronous rectifiers adapted to operate with an overlapping conduction phase and a fixed frequency.

### FIELD

The present invention relates to a resonant electrical power converter for direct current (DC) power.

### BACKGROUND

Resonant power converters are used for DC to DC power conversion as they can exhibit low power loss, reduce electromagnetic current emissions and are capable of zero voltage switching (ZVS) operation. Existing resonant power converters still, however, have limitations on their power efficiency, either for high load or low load cases, can exhibit undesirable output power characteristics, and can be expensive to manufacture.

For example, a variable-frequency parallel-loaded resonant converter with inductive output can have a high tank current at full load and therefore require large and/or expensive electronic components, have significant electrical losses when lightly loaded, and generate high voltage stresses over the output diodes when there is no electrical load. A parallel-loaded inductor-capacitor-capacitor (LCC) resonant converter has improved performance, but typically generates a high voltage stress on its output capacitor for low voltage outputs (due to high output ripple), may require phase detection to prevent operation below resonance, and may generate undesirable losses due to multiple resonances in the output diodes.

A resonant power converter should be as efficient as possible whilst minimising complexity and the use of expensive components.

Accordingly, it is desired to address the above, or at least provide a useful alternative.

### SUMMARY

In accordance with the present invention there is provided a resonant power converter including synchronous rectifiers adapted to operate with an overlapping conduction phase.

The present invention also provides a resonant power converter operating at fixed frequency, including:

a resonant circuit, with a resonant voltage at the fixed frequency, on a primary side of an isolating unit; and

an output circuit on a secondary side of the isolating unit, coupled by the isolating unit to the resonant circuit, including switches for conducting during respective overlapping conduction phases, and for generating a DC voltage at an output of the converter.

The present invention also provides a control unit for a resonant power converter with synchronous rectifiers operating at a fixed frequency, including:

a sensor circuit for sensing electrical power in the resonant power converter; and

control circuits for controlling the synchronous rectifiers, based on the sensed electrical power,

wherein the synchronous rectifiers are controlled to have an overlapping conduction phase.

The present invention also provides a method of operating a fixed frequency resonant power converter having output synchronous rectifiers, including controlling the rectifiers to operate with overlapping conduction phases.

### DESCRIPTION OF THE DRAWINGS

Preferred embodiments of the present invention are hereinafter described, by way of example only, with reference to the accompanying drawings, which are not to scale, wherein:

FIG. 1 is a circuit diagram of an overlapping conduction phase power converter;

FIG. 2 is a flow chart of a switching process performed by the overlapping conduction phase power converter;

FIG. 3 is a chart of voltage and current wave forms in the time domain in the overlapping conduction phase power converter;

FIG. 4 is a circuit diagram of the converter including an active clamp;

FIG. 5 is a circuit diagram of the converter including a resonant clamp circuit;

FIG. 6 is a circuit diagram of the converter with rectifiers in a full bridge configuration;

FIG. 7 is a circuit diagram of the converter with a current transformer sensing the tank current;

FIG. 8 is a circuit diagram of the converter with a voltage sensing circuit on the secondary side for sensing the tank current; and

FIG. 9 is a circuit diagram of the converter with synchronous rectifiers in a full bridge configuration.

### DETAILED DESCRIPTION

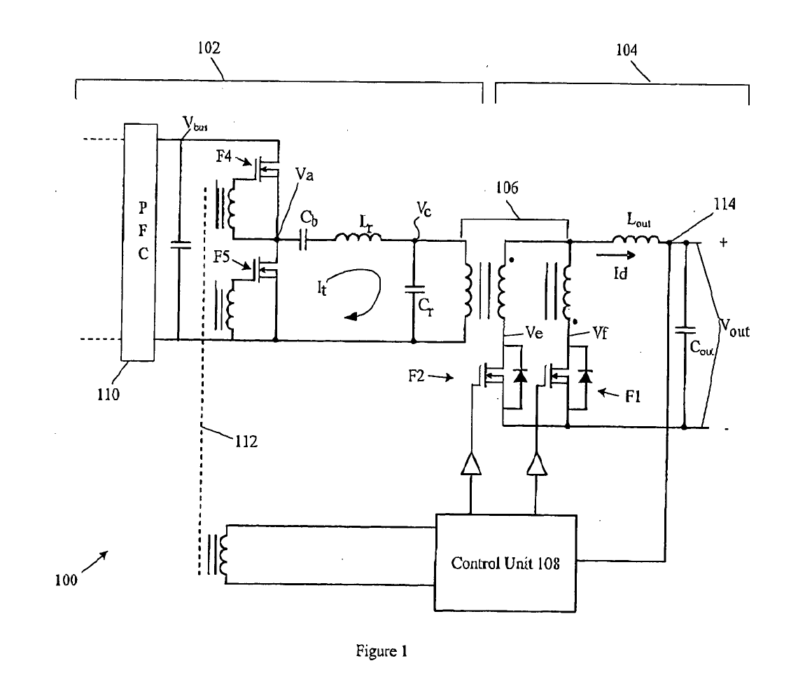

An overlapping conduction phase power converter in the form of a fixed frequency inductor-capacitor (LC) resonant converter, or “FFLC” 100, shown in FIG. 1, includes a primary side 102 with a resonant circuit connectable to an input electrical power supply (not shown) and a secondary side 104 with an output circuit connectable to an electrical load (not shown), the primary and secondary sides being joined by an electrical transformer 106. and being controlled by a control unit 108.

The input supply is connectable to the primary side 102 through a power factor correction (PFC) unit 110 for correcting the power factor of the input electrical supply to provide a DC input supply in the form of a DC bus, V_{bus}. The DC input supply can be derived by various techniques such as power factor correction (with the PFC unit 110), or using a bridge rectifier and capacitive filter, or supplying the DC bus directly from a DC power source.

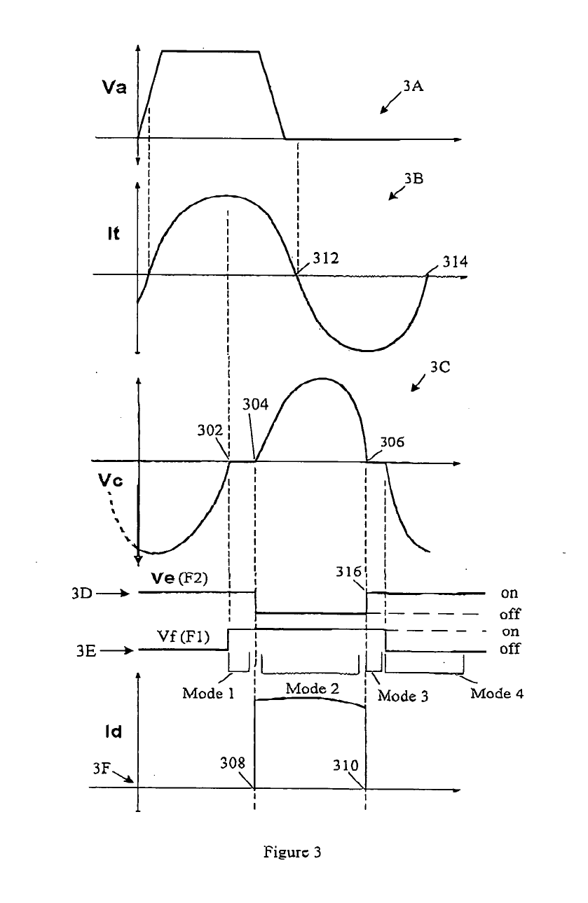

The FFLC 100 uses a fixed resonant frequency ƒᵣ on the primary side 102 generated by primary side MOSFETs F4, F5 driven at the fixed frequency ƒᵣ. The primary side FETs F4, F5 are connected in series across the DC bus. The primary side FETs F4, FS are driven at the fixed frequency ƒᵣ by the control unit 108 using a primary control transformer 112 having secondary windings connected to the gates of the primary side FETs F4, F5, as shown in FIG. 1. The primary side FETs F4, F5 generate a fixed frequency waveform, e.g. a quasi square or a quasi sinusoidal wave, at their output circuit node Vₐ, as shown in the Vₐ-waveform in FIG. 3A. The resonant voltage at circuit node Vₐ generates a resonant “tank” current Iₜ, as shown in the Iₜ waveform in FIG. 3B, through a resonant tank circuit which includes a blocking capacitor C_{b}, a resonant inductor Lᵣ and a resonant capacitor Cᵣ which arc in series between the source and drain nodes of the primary side FET F5.

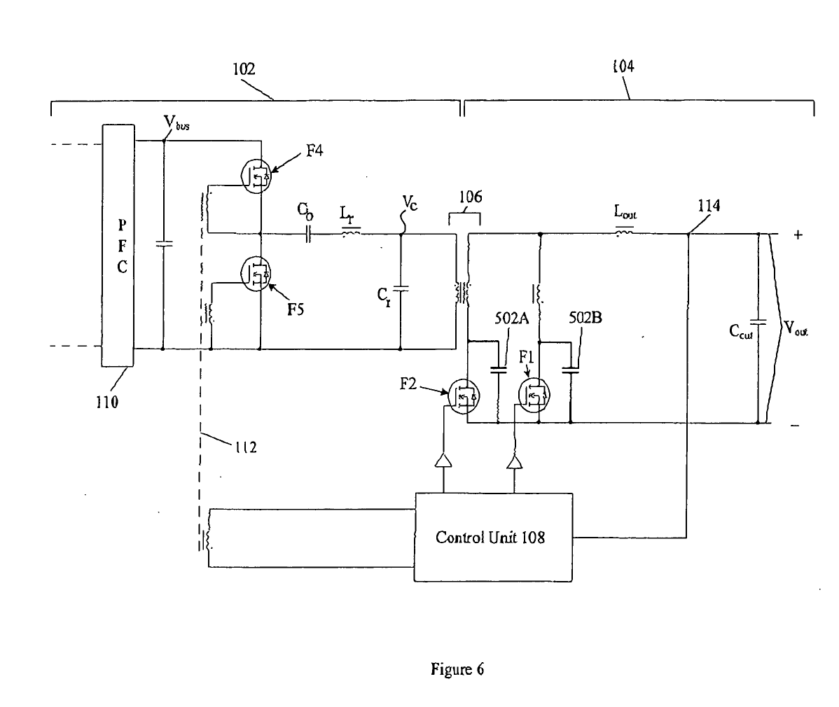

The control circuit 108 may be located either on the primary side or on the secondary side (as shown in FIGS. 1 and 4 to 8). The control circuit 108 is coupled to the other side by isolating devices (e.g. transformer 112, as shown in FIGS. 1 and 4 to 8).

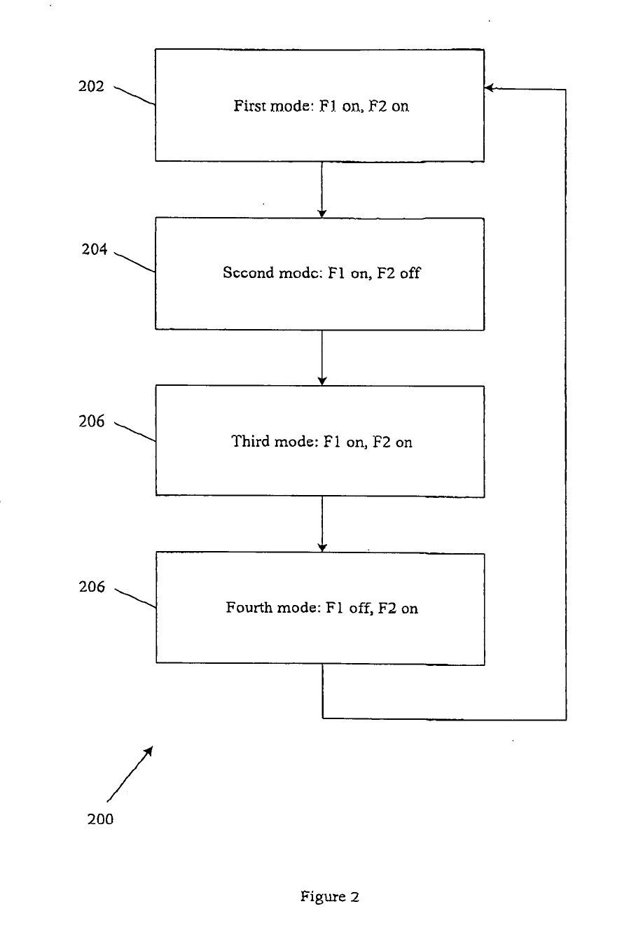

The secondary side 104 is connected by the transformer 106 in parallel with the resonant capacitor Cᵣ, and the impedance of the secondary side is dynamically controlled by secondary side MOSFETs F1, F2, which are electronically controlled by the control unit 108. The secondary side FETs F1, F2 are switched between on and off states, as shown in FIGS. 3D and 3E, thus cycling through four modes, as shown in FIG. 2. The secondary side FETs F1, F2 are connected in series, respectively, with secondary windings of the transformer 106 tapped for positive and negative voltages, respectively. Diodes are connected respectively in parallel with the secondary side FETs F1, F2 with their anodes connected to the drains of the secondary side FETs F1, F2.

The resonant frequency ƒᵣ is set by the resonant components Lr and Cr. The control unit 108 ensures the converter has a 50% duty cycle, and operates above the natural resonant frequency of the “tank” circuit, thereby generating the quasi sinusoidal tank current Iₜ, shown in FIG. 3B The converter operates above resonance to achieve zero voltage switching over the operating range and the duty cycle of 50% is selected for balanced operation. Accordingly, the timing of the primary side FETs F4, F5 is arranged such that they switch when the central voltage Vₐ in the tank circuit has reached zero due to the resonant frequency ƒᵣ of the tank circuit, which determines the frequency of the tank current Iₜ, e.g. as shown in FIG. 38.

The resonant capacitor Cᵣ is charged by the tank current Iₜ to generate a periodic capacitor voltage Vₒ as shown in FIG. 3C. The secondary side FETs F1, F2 are switched synchronously with the capacitor voltage V_{c}, such that switching occurs when the capacitor voltage V_{c} is zero; this is known as Zero Voltage Switching (ZVS) and advantageously allows the secondary side FETs F1, F2 to switch efficiently and with low voltage stress.

The secondary side FETs F1, F2, under control of the control unit 108, are switched in a converter process 200, including a repetitive four mode cycle, shown in FIG. 2. In a first mode (step 202), the FET F1 is switched on when the resonant capacitor voltage V_{c}, which is driven by the tank current Iₜ, reaches zero, i.e. at point 302 in FIG. 3C. In the first mode, the FET F2 is also on, and thus the two secondary side FETs F1, F2 overlap in their conduction phases; however, as the resonant capacitor voltage V_{c}, which is proportional to the voltage over the secondary side FETs F1, F2, is equal to zero, thus the resonant capacitor Cᵣ is “shorted out” and the tank current Iₜ is increasing linearly in this phase. The value of the resonant inductor Lᵣ is selected such that the tank current L is minimised for losses. The FFLC 100 remains in the first mode for a period of time T₁ which is set by the control circuit, e.g. T1 has a duration ranging between 0% and 20% of the overall period.

In a second mode (step 204) activated by the control unit 108 and following the first mode, the FET F2 is turned off, thereby allowing a voltage to appear across the resonant capacitor Cᵣ, and thus this resonant capacitor voltage V_{c} acts in a resonant way, i.e. following an approximate half-wave sinusoid, as shown in FIG. 3C between points 304 and 306. The transformer 106, in response to the resonant capacitor voltage V_{c} on the primary side, generates a secondary side voltage across the FET F2, thereby generating an output voltage Vₒᵤₜ and an output diode load current I_{d}, as shown in FIG. 3F between points 308 and 310 (corresponding to points 304 and 306 of V_{c}). The second mode is sustained until the resonant capacitor voltage V_{c} returns to zero due to negative charging of the resonant capacitor Cᵣ by the negative phase of the tank current Iₜ (i.e. the tank current Iₜ falling below zero between points 312 and 314 in FIG. 3B).

Following the second mode, a third mode is activated by the control unit 108 (step 206) in which the FET F2 is again turned on, at point 316 (shown in. FIG. 3D and corresponding to points 306 and 310), and thus the voltage across the resonant capacitor is again shorted to zero. The third mode is similar to the first mode except that the resonant capacitor is being charged by the tank current Iₜ flowing in an opposite direction. The third mode is sustained by the control unit 108 for a duration T₃ approximately equal to T, (e.g. between 0% and 20% of the overall period 1/fᵣ).

A fourth mode is activated by the control unit 108 (step 208) following the third mode, in which the FET F2 is switched off, while the FET F1 remains on. The fourth mode is similar to the second mode, except the resonant capacitor voltage V_{c} is reversed, and thus the secondary side of the transformer 106 is connected to the load via the FET F2 rather than the FET F1, thereby generating a second pulse of load current I_{d} in the same direction as the load current I_{d} generated during the second mode (not shown in FIG. 3F), i.e. generating DC electrical power for the load.

Following the fourth mode, the first mode is again activated by the control unit 108.

The output current I_{d} of the FFLC 100 is generated as a series of pulses which occur during the second mode and the fourth mode, and the positive pulses have durations which are controlled by controlling the durations of the second mode and the fourth mode via the control unit 108. The current pulses in the output current I_{d} corresponding to the second and fourth modes are separated by periods of zero load current corresponding to the first and third modes, i.e. during the overlapping conduction phases of the secondary side FETs F1, F2. The control unit 108 therefore controls the long term average of the output current by controlling the durations of the first, second, third and fourth modes; this method of long-term average voltage control is similar to that of output power control by pulse width modulation (PWM).

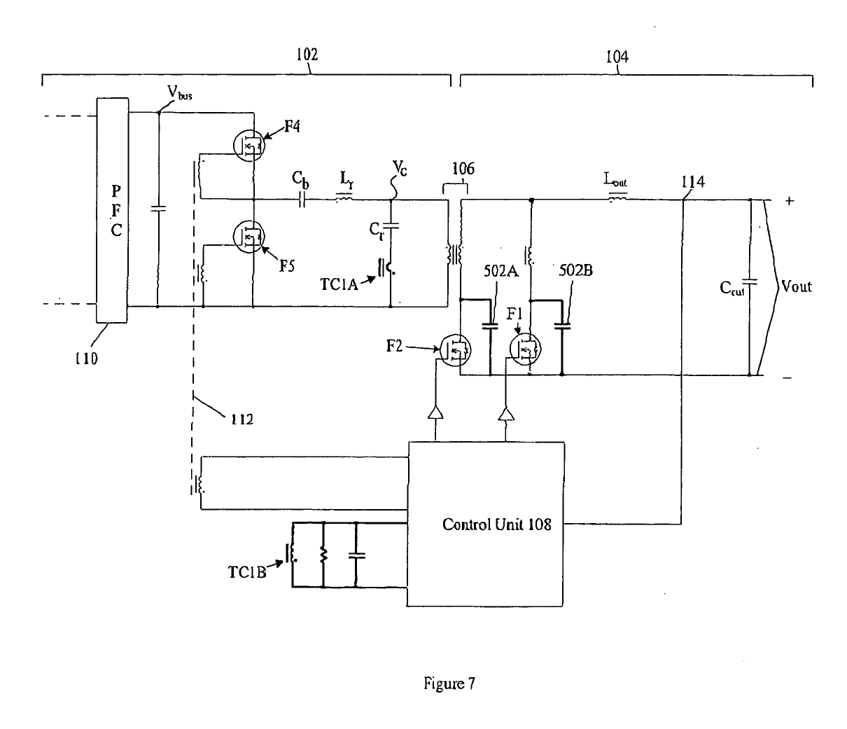

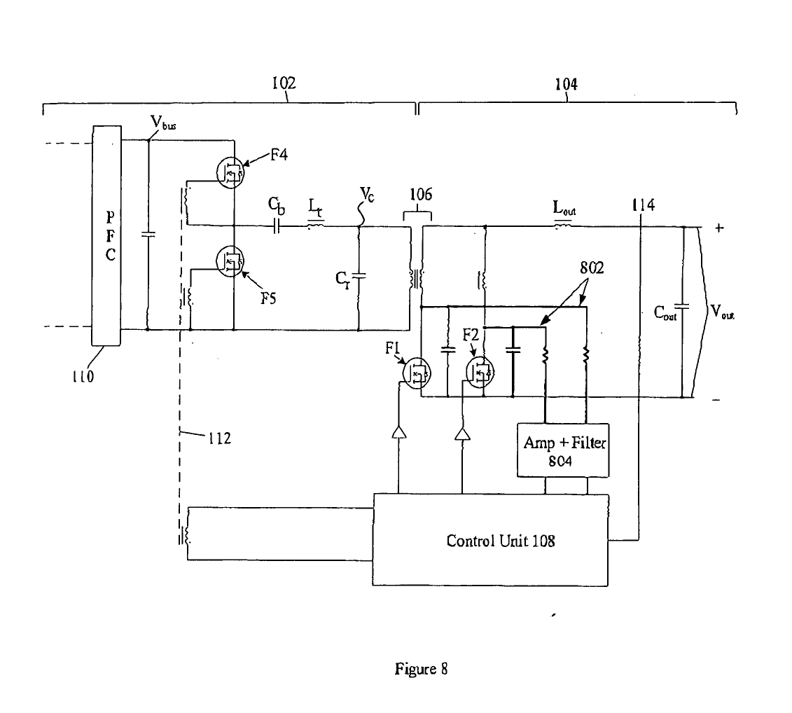

The control unit 108 generates simple periodic control signals to cycle the secondary side FETs F1, F2 between the first, second, third and fourth modes, and to switch the primary side FETs F4, F5 to generate the periodic voltage signal for the resonant or “tank” circuit. The control unit 108 receives an output voltage signal (representing the output voltage Vₒᵤₜ) from the secondary output node 114. The control unit 108 receives a resonant voltage signal (representing the tank current Iₜ), either by sensing the current through Cᵣ using a current transformer TCIA-B, as shown in FIG. 7, or by sensing the voltage across the secondary side FETs F2, F1 using a voltage sensing circuit 802 and an electronic amplifier/filter circuit 804, as shown in FIG. 8. The voltage sensing circuit 802 includes a resonant clamping capacitor over each secondary side FET F2, F1, and a resistor connecting one terminal of each secondary side FET F1, F2 to the amplifier/filter circuit 804. The resonant voltage signal is used by the control unit 108 to predict the zero voltage switching (ZVS) time of the secondary side FETs F1, F2.

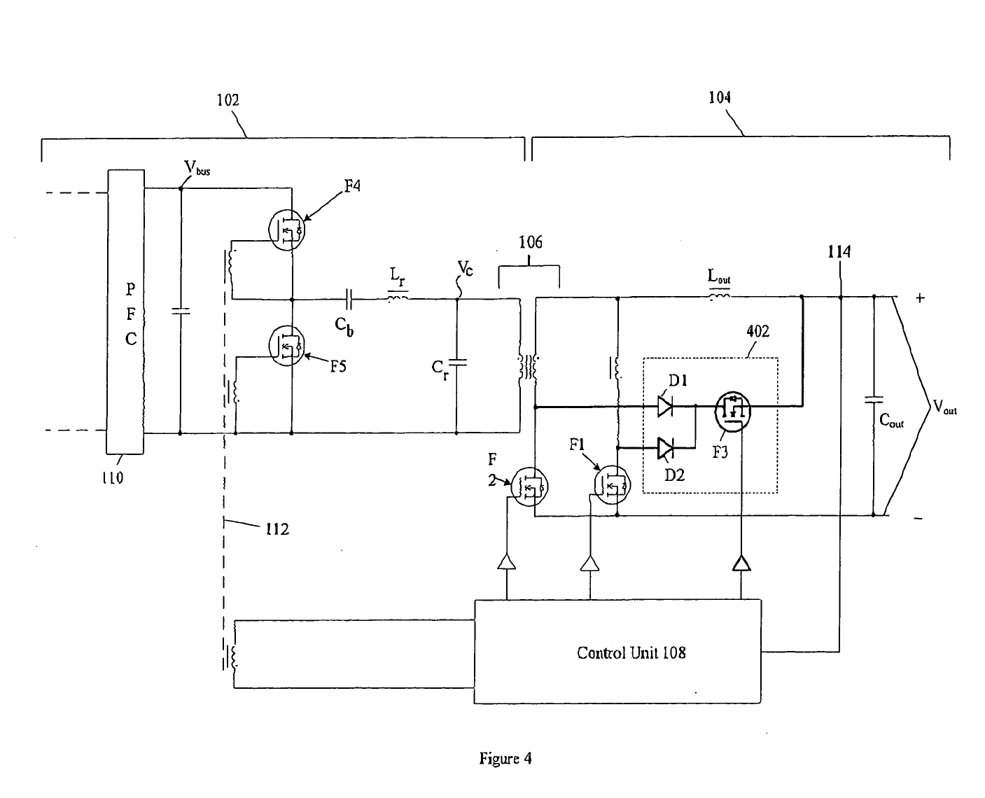

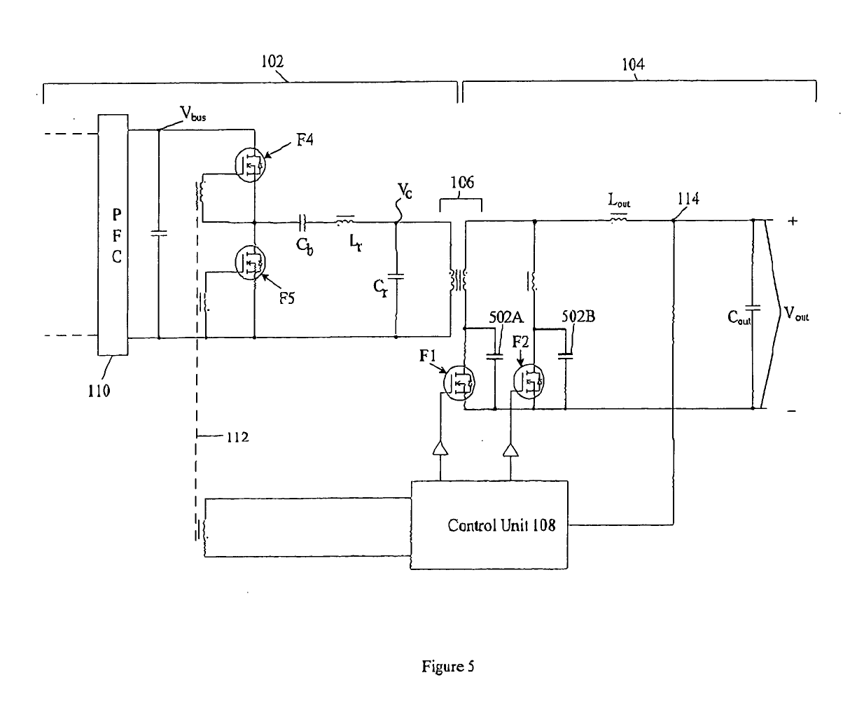

During the second mode, any excess energy stored in a secondary winding leakage “stray” inductance is routed to the output of the FFLC 100 through clamping circuit 402, shown in FIG. 4. The clamping circuit 402, including clamping diodes D1, D2 and a clamping MOSFET F3 (either P or N channel), provides an “active clamp”: the energy stored in the stray inductance is clamped to the output by turning on the clamping FET F3 just before the secondary side FETs F1, F2 are turned off, i.e. just before the end of the first mode and just before the end of the third mode, thus preventing voltage transients in the corresponding secondary side FET as its being turned off, i.e. either F1 or F2. The active clamp allows lower-voltage FET components to be used for the secondary side FETs F1, F2, which are less lossy, and result in lower conduction losses. Alternately, any excess energy stored in the secondary winding leakage “stray” inductance may be controlled by a resonant clamp circuit as shown in FIG. 5. This circuit consists of additional clamping capacitors 502A, 502B fitted across each of the secondary side FETs F1, F2 that form part of the overall resonant capacitance, Cr.

During the overlapping conduction phase, i.e. during the first mode and the third mode, the resonant tank current is only a small percentage of the overall output current of the FFLC 100 during the first, second, third and fourth modes. This advantageously allows for a high power efficiency in the FFLC 100.

The control unit 108 includes a digital signal processor, pre-programmed to control the FFLC 100. The modulation commands for the primary and secondary side FETs F4, FS, F1, F2 are generated by the control unit 108 based on digital control programs stored on the DSP. The digital control programs provide circuit alignment for slight variations in electronic component values, e.g. to allow for consistent operation of the FFLC 100 regardless of slight variations in the component values such as the resonant inductor Lᵣ and the resonant resistor R_{c} from the selected desired values.

As the FFLC 100 operates at the fixed, or set, resonant frequency ƒᵣ , the magnetic components, including resonant inductor Lᵣ and the resonant capacitor Cᵣ, need only be provided by physical devices which are optimised to operate at the particular frequency ƒᵣ, and therefore may be more robust and/or less expensive than components which are optimised for a broader range of operational frequencies. The particular operational frequency ƒᵣ is selected depending on the final application of the FFLC 100 and the overall power system environment. Typically the resonant frequency is optimised in the range of 400 kHz to 700 kHz. The resonant frequency ƒᵣ may be increased to a frequency where the leakage inductance of the transformer 106 can replace the series resonant inductor Lᵣ; such a high-frequency FFLC 100 is contained in advanced magnetically optimised packaging. In such cases the frequency is typically optimised in the range of 1 MHz to 2 MHz.

Resonant conversion in the FFLC 100 provides advantages including the zero voltage switching (ZVS) which results in low generated electromagnetic interference (EMI) and thus easier achievement of electromagnetic compatibility (EMC) requirements, the possibility of high frequency operation and compact magnetic design along with high power efficiency, and high power density. The control unit 108 with advanced control techniques allows for significant reduction in component count.

The FFLC 100 may be used in applications with requirements in the power range of 50 watt to 5 kilowatt.

The FFLC 100 may be controlled by the control unit 108 to operate in a “burst” mode for reducing power losses in the FFLC 100 when the electrical load is small, i.e. when the load is drawing a low current. The control unit 108 controls the primary side FETs F4, F5 in the burst mode in which pulses are dropped on the primary side 102, depending on output power, thereby missing cycles in the wave forms shown in FIG. 3, and generating lower output power at a greater efficiency. The burst mode, or other pulse thinning techniques, allows for a higher efficiency operation for low current loads in the electrical load.

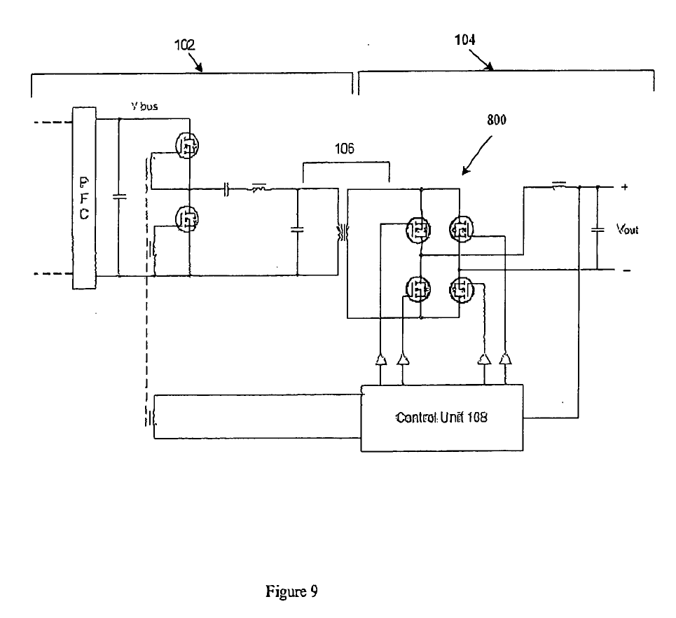

The secondary side FETs F1, F2 arc arranged in a centre-tapped configuration. In an alternative FFLC, the synchronous rectifiers may be arranged in a full bridge configuration 800, as shown in FIG. 9.

The FFLC 100 has a parallel loaded secondary side, i.e. the output circuit load of the secondary side is in parallel with the resonant capacitor Cᵣ. In an alternative FFLC, the secondary side may be loaded in series with the resonant tank circuit, i.e. the transformer 106 is in series with the resonant components Lᵣ and Cₜ.

The components in the FFLC 100 endure a low voltage stress. The secondary diode current I_{d} has no multi-resonance. The secondary diode current I_{d} is low due to the inductive output, i.e. provided by the output inductor Lₒᵤₜ. The active clamp circuit limits high current spikes. At light or no load the primary tank current is 80% of what it is at full load, this results in lower power losses than convention circuits for this loading condition.

The capacitive component ‘Cₒᵤₜ’ is used for “bulk” output capacitance and is required for feedback loop stability and ripple voltage reduction.

A smaller inductor component is required compared to non-fixed frequency power converters, e.g. the inductor size may be 50% of parallel loaded variable-frequency power converters that have a non-fixed, or variable, resonant frequency.

The overlapping conduction phases, i.e. in the first mode and the third mode, allows for small timing errors, e.g. jitter etc., to occur without greatly altering the characteristics of the output diode current T_{d}.

The cross-conducting, or overlapping, conduction phases of the secondary sides synchronous rectifiers F1 and F2 also allow for continuously variable and flexible control of the output power of the FFLC 100. The percentage of each cycle (i.e. a cycle through all modes) for which the overlapping conduction phase exists, i.e. the sum of the first and third modes, is varied between approximately 0% and approximately 40% to provide control of the output power from the FFLC 100. However if output voltage control to 0V is required then the overlap can extend all the way to 100%.

Many modifications will be apparent to those skilled in the art without departing from the scope of the present invention as herein described with reference to the accompanying drawings.

1. A resonant power converter operating at a fixed frequency, including:
a resonant circuit, with a resonant voltage at the fixed frequency, on a primary side of an isolating unit; and
an output circuit on a secondary side of the isolating unit, coupled by the isolating unit to the resonant circuit, including switches for conducting during respective overlapping conduction phases, and for generating a DC voltage at an output of the converter.

2. A resonant power converter as claimed in claim 1, wherein switching of the switches is synchronised with the resonant voltage and switch when a voltage over the switches is substantially zero.

3. A resonant power converter as claimed in claim 1, including a control unit for controlling the switches.

4. A resonant power converter as claimed in claim 3, wherein the control unit is on the secondary side of the isolating unit and coupled to the primary side by a control isolating device.

5. A resonant power converter as claimed in claim 3, wherein the control unit is on the primary side of the isolating unit and coupled to the secondary side by a control isolating device.

6. A resonant power converter as claimed in claim 4, wherein the control isolating device is a control transformer.

7. A resonant power converter as claimed in claim 3, wherein the control unit receives an output voltage signal, representative of an output voltage of the converter, for adjusting overlap of the conduction phases.

8. A resonant power converter as claimed in claim 3, wherein the control unit receives an resonant voltage signal, representative of the resonant voltage, for controlling the switches in synchronicity with the resonant voltage.

9. A resonant power converter as claimed in claim 8, wherein the control unit receives the resonant voltage signal by sensing electrical current in the resonant circuit.

10. A resonant power converter as claimed in claim 9, including a current transformer in series in the resonant circuit for sensing the electrical current.

11. A resonant power converter as claimed in claim 8, including a voltage sensor for sending the resonant voltage signal to the control unit by sensing voltages over the switches.

12. A resonant power converter as claimed in claim 11, wherein the voltage sensor includes a voltage sensing circuit and an amplifier/filter for each switch.

13. A resonant power converter as claimed in claim 3, wherein the control unit includes a digital signal processor for controlling the converter.

14. A resonant power converter as claimed in claim 1, wherein the output circuit is in parallel with the resonant circuit.

15. A resonant power converter as claimed in claim 1, wherein the output circuit is in series with the resonant circuit.

16. A resonant power converter as claimed in claim 1, wherein the switches are arranged in a centre-tapped configuration.

17. A resonant power converter as claimed in claim 1, wherein the switches are arranged in a full bridge configuration.

18. A resonant power converter as claimed in claim 1, wherein the resonant circuit includes a resonant inductor and a resonant capacitor.

19. A resonant power converter as claimed in claim 18, wherein the resonant inductor and resonant capacitor are in parallel.

20. A resonant power converter as claimed in claim 18, wherein the resonant inductor and resonant capacitor are in series.

21. A resonant power converter as claimed in claim 18, wherein the resonant inductor is provided by leakage inductance of the isolating unit.

22. A resonant power converter as claimed in claim 1, wherein the resonant circuit includes a blocking capacitor.

23. A resonant power converter as claimed in claim 1, including a clamping circuit for discharging stored energy in a stray inductance of the secondary side of the isolating unit to the output of the converter.

24. A resonant power converter as claimed in claim 23, wherein the clamping circuit is an active clamp including clamping diodes, each connected to one terminal of each switch and the output via a clamping switch.

25. A resonant power converter as claimed in claim 23, wherein the clamping circuit is a passive clamp including a clamping capacitor across each switch.

26. A resonant power converter as claimed in claim 1, wherein the switches include switchable transistors in parallel with diodes.

27. A resonant power converter as claimed in claim 1, wherein the isolating unit is a transformer, with a primary winding on the primary side and a secondary winding on the secondary side.

28. A resonant power converter as claimed in claim 1, wherein the conduction phases overlap by between zero and forty percent of each period of the resonant frequency.

29. A resonant power converter as claimed in claim 1, wherein the DC output is variable.

30. A resonant power converter including synchronous rectifiers adapted to operate with an overlapping conduction phase and a fixed frequency.

31. A control unit for a resonant power converter with synchronous rectifiers operating at a fixed frequency, including:
a sensor circuit for sensing electrical power in the resonant power converter; and
control circuits for controlling the synchronous rectifiers, based on the sensed electrical power, wherein the synchronous rectifiers are controlled to have an overlapping conduction phase.

32. A method of operating a fixed frequency resonant power converter having output synchronous rectifiers, including controlling the rectifiers to operate with overlapping conduction phases.
